(19) United States
(12) Patent Application Publication
(10) Pub. No.: US 2009/0318151 A1
(43) Pub. Date: Dec. 24, 2009

(54) APPARATUS AND METHOD FOR SUPPORTING HANDOVER IN MOBILE COMMUNICATION TERMINAL WITHOUT GPS

(75) Inventors: Bu-Seop JUNG, Suwon-si (KR); Kamal Rafiq Mohammed, Suwon-si (KR); Hyuk-Beom KWON, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/480,448

(22) Filed: Jun. 8, 2009

(30) Foreign Application Priority Data
Jun. 18, 2008 (KR) 10-2008-0057167

(51) Int. Cl. H04W 36/00

(52) U.S. Cl. 455/436

(57) ABSTRACT

An apparatus and method for supporting a handover of a mobile terminal without a Global Positioning System (GPS) are provided. The method includes receiving a sub-cell IDentifier (ID) from a Base Station (BS) using Transmission Parameter Signaling (TPS), recognizing a location of the mobile terminal using the received sub-cell ID, and determining a candidate group of adjacent cells, to which the handover is possible, using the recognized location information of the mobile terminal. Accordingly, the mobile terminal may performs a handover within a short period of time, and a seamless service may be provided by avoiding a possibility that a service Further, in comparison with the conventional handover, power consumption may be reduced by decreasing a frequency search time of an adjacent cell during an off time.

### PRIORITY

This application claims the benefit under 35 U.S.C. §119(a) of a Korean patent application filed in the Korean Intellectual Property Office on Jun. 18, 2008 and assigned Serial No. 10-2008-0057167, the entire disclosure of which is hereby incorporated by reference.

### BACKGROUND OF THE INVENTION

1. Field of the Invention

The present invention relates to an apparatus and method for supporting a handover of a mobile terminal without a Global Positioning System (GPS). More particularly, the present invention relates to an apparatus and method for transmitting a sub-cell IDentifier (ID) to support a handover of a mobile terminal without a GPS in a Digital Video Broadcasting-Handheld (DVB-H) system.

2. Description of the Related Art

Digital Video Broadcasting-Handheld (DVB-H) is a mobile broadcast standard in which Digital Video Broadcasting-Terrestrial (DVB-T), which is a European terrestrial broadcasting standard, is modified according to the concept of a mobile broadcast service.

Unlike a handover in a conventional cellular communication system, a system based on DVB-H supports a passive handover without a return channel. When performing a passive handover in a DVB-H system, a mobile terminal has to perform the handover without the aid of other elements by only using information transmitted through a network.

The DVB-H system uses a time slicing scheme which is a significant characteristic of the DVB-H system. The time slicing scheme is a multiplexing scheme in which the capacity of a transmission path is divided into specific time slots and then a packetized broadcast signal is carried and transmitted on each time slot. When a Base Station (BS) transmits a broadcast signal using the time slicing scheme, a mobile terminal receives the broadcast signal by being switching on only for the period in which a burst is transmitted through a channel selected by a user. That is, when using a conventional time slicing scheme, as shown in FIG. 1, the mobile terminal is switched on only in a specific time slot selected by the user and with a specific time period AT, and is switched off in the remaining time periods. As a result, there is an advantage in that power consumption may be theoretically reduced by 90% or more. In addition, during a handover process, the time slicing scheme supports a seamless handover. That is, in a situation where the mobile terminal has to move from a current cell to another cell, the mobile terminal may perform the seamless handover during an off time 100 without having an effect on a previously received burst.

The DVB-H system performs a handover in three steps including handover measurement, handover decision-making, and handover execution.

In the handover measurement step, parameters that will be used in the handover decision-making step are measured. Examples of the measured parameters include a Received Signal Strength Indicator (RSSI), a Signal to Noise Ratio (SNR), etc. When the mobile terminal has a Global Positioning System (GPS) function, location information of the mobile terminal may also be measured in addition to the parameters such as the RSSI, the SNR, etc. In the handover decision-making step, a frequency and a cell to which the mobile terminal may be moved by performing the handover according to a predetermined handover algorithm are determined on the basis of the parameters measured in the handover measurement step. In the handover execution step, the mobile terminal is actually moved to the cell determined in the handover decision-making step.

In the handover measurement and decision-making steps, the mobile terminal generally uses Transmission Parameter Signaling (TPS) and a Network Information Table (NIT) included in Program Specific Information (PSI)/Service Information (SI). In the DVB-H system, a cell IDentifier (ID) that is capable of identifying each cell is transmitted using the TPS, and the mobile terminal identifies each cell using the cell ID of the TPS.

The BS announces all frequencies and cell IDs used in a service to the mobile terminal by using the PSI/SI, and also announces a location and service coverage area of each BS. Therefore, when a predetermined parameter (i.e., RSSI, SNR, etc.) decreases below a reference value, the mobile terminal sequentially searches frequencies of all cells used in a current network without having to search all potential frequencies. In general, by using location information of each BS, the mobile terminal performs a search operation on RSSIs and SNRs from a frequency of a most adjacent cell during an off time. As a result of the search operation, a cell having a reception sensitivity level (e.g., RSSI and SNR) sufficient to perform a handover is determined as a handover candidate cell by the mobile terminal.

In the above described procedure, as the time required to perform the aforementioned step of measuring reception sensitivity of other frequencies during the off time increases, the actual off time decreases. Thus, it is apparent that power consumption correspondingly increases. In particular, for a mobile terminal which is frequently handed over, the benefits from the power reduction effect achieved by the time slicing are minimized. For example, in a conventional Multi Frequency Network (MFN) environment of FIG. 2, if a handover situation occurs when a user in a 1^{st} cell 200 moves to a cell edge, a mobile terminal 201 has to search up to 7 adjacent cells. This is because a mobile terminal that does not have a GPS is not able to know the location of the BS, and thus has to determine an RSSI and an SNR of each frequency until satisfactory received sensitivity is found. As a result, the benefits from the power reduction effect are minimized. Further, a cell to which a handover is to be performed may not be rapidly found in a situation of high-speed movement by which reception sensitivity of a current cell sharply decreases. In this case, a current service may be disconnected. In addition, power consumption also increases in a frequent handover situation. If the mobile terminal includes the GPS, it is sufficient to search only cells in a movement direction without having to search frequencies of all cells. However, when the GPS is installed in a mobile terminal for general use, it may result in an increase in cost and complexity of the mobile terminal. Further, operating of the GPS in a compact DVB-H mobile terminal consuming low power may cause non-negligible power consumption.

Although it is defined that a cell ID is transmitted using the TPS, a transmission rule for cell ID extension in association with a sub-cell ID is not defined in the standard. In an actual specification, sub-cell information is specified as optional and its transmission rule is not specified. Therefore, there is a need to propose a method of transmitting the sub-cell ID.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for transmitting a sub-cell IDentifier (ID) by a Base Station (BS) to a mobile terminal without a Global Positioning System (GPS) by using Transmission Parameter Signaling (TPS) in a Digital Video Broadcasting-Handheld (DVB-H) system.

Another aspect of the present invention is to provide an apparatus and method in which a mobile terminal without a GPS recognizes a location of the mobile terminal by using a sub-cell ID obtained by receiving TPS from a BS in a DVB-H system and uses the recognized location to reduce a candidate group of adjacent cells to which a handover is possible.

Another aspect of the present invention is to provide an apparatus and method for transmitting a sub-cell ID by using 4 reserved bits among TPS bits in a DVB-H system.

In accordance with an aspect of the present invention, a method of supporting a handover of a mobile communication terminal is provided. The method includes receiving a sub-cell ID from a BS using TPS, recognizing a location of the mobile terminal using the received sub-cell ID, and determining a candidate group of adjacent cells, to which the handover is possible, using the recognized location information of the mobile terminal.

In accordance with another aspect of the present invention, an apparatus for supporting a handover of a mobile communication terminal is provided. The apparatus includes a receiver for receiving a sub-cell ID from a BS using TPS, and a controller for recognizing a location of the mobile terminal by using the received sub-cell ID, and for determining a candidate group of adjacent cells, to which the handover is possible, by using the recognized location information of the mobile terminal.

In accordance with yet another aspect of the present invention, an apparatus of a Base Station (BS) for supporting a handover of a mobile communication terminal is provided. The apparatus includes a cell IDentifier/sub-cell IDentifier (cell ID/sub-cell ID) generator for generating a cell ID and a sub-cell ID, a Transmission Parameter Signaling (TPS) generator for generating TPS including the cell ID and sub-cell ID, and a transmitter for transmitting the TPS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates an operational principle of a conventional time slicing scheme of a Digital Video Broadcasting-Handheld (DVB-H) system;

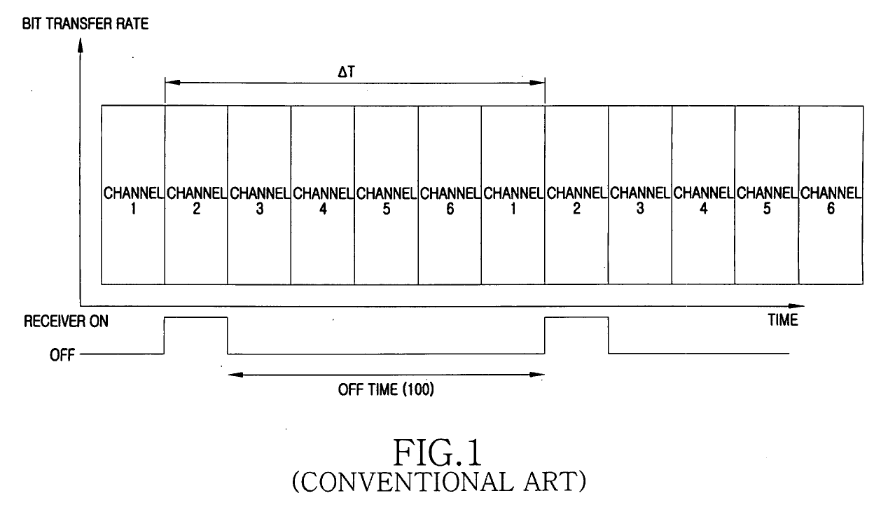

FIG. 2 illustrates a conventional cell layout in a Multi Frequency Network (MFN) environment;

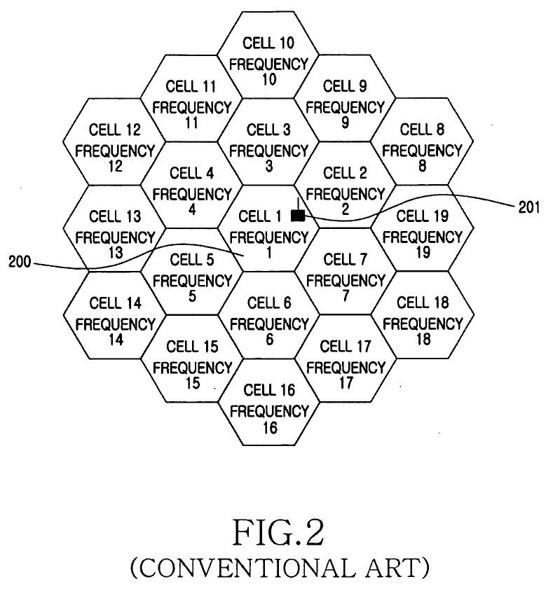

FIG. 3 is a block diagram illustrating a transmitting apparatus of a Base Station (BS) in a DVB-H system according to an exemplary embodiment of the present invention;

FIG. 4 is a block diagram illustrating a mobile terminal in a DVB-H system according to an exemplary embodiment of the present invention;

FIG. 5 is a block diagram illustrating an apparatus for determining a target adjacent cell to which a controller of a mobile terminal without a Global Positioning System (GPS) performs a handover by recognizing a location of the mobile terminal in a DVB-H system according to an exemplary embodiment of the present invention;

FIG. 6 is a flowchart illustrating a method of determining a target adjacent cell to which a mobile terminal without a GPS performs a handover by recognizing a location of the mobile terminal in a DVB-H system according to an exemplary embodiment of the present invention;

FIG. 7 illustrates a sub-cell IDentifier (ID) of each sector when a cell is divided into 6 sectors in a DVB-H system according to an exemplary embodiment of the present invention;

FIG. 8 illustrates a method of determining a difference angle between adjacent cells by using latitude and longitude information of each cell in a DVB-H system according to an exemplary embodiment of the present invention; and

FIG. 9 illustrates a method of determining a target adjacent cell to which a mobile terminal performs a handover by recognizing a location of the mobile terminal when a cell is divided into 6 sectors in a DVB-H system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention described hereinafter relate to an apparatus and method for transmitting a sub-cell IDentifier (ID) to support a handover of a mobile terminal without a Global Positioning System (GPS) in a Digital Video Broadcasting-Handheld (DVB-H) system. When each cell is divided into several sectors using sector antennas, the sub-cell ID contains location information on each cell. In exemplary embodiments of the present invention, each sector is substantially the same concept as a sub-cell on the specification.

The following description assumes that a Base Station (BS) of each cell uses a directional antenna rather than an omni-directional antenna. In a conventional cellular mobile communication, the BS uses the directional antenna which is generally referred to as a sector antenna. However, exemplary embodiments of the present invention are different from the conventional cellular mobile communication in that the directional antenna of each cell does not use a different frequency to identify each cell but all sectors of each cell use the same frequency.

In exemplary embodiments of the present invention, a Network Information Table (NIT) of Program Specific Information (PSI)/Service Information (SI) includes cell_list_descriptor of Table 1 below and cell_frequency_link descriptor of Table 2 below.

TABLE 1

| Syntax | Number of bits |
|---|---|
| cell_list_descriptor( ){ | |
| descriptor_tag | 8 |
| descriptor_length | 8 |
| for (i=0; i<N; i++){ | |
| cell_id | 16 |
| cell_latitude | 16 |
| cell_longitude | 16 |
| cell_extent_of_latitude | 12 |
| cell_extent_of_longitude | 12 |
| subcell_info_loop_length | 8 |
| for (j=0; j<N; j++){ | |
| cell_id_extension | 8 |
| subcell_latitude | 16 |
| subcell_longitude | 16 |
| subcell_extent_of_latitude | 12 |
| subcell_extent_of_longitude | 12 |
| } | |
| } | |
| } | |

As shown in Table 1 above, the cell_list_descriptor includes a descriptor_tag field for identifying a descriptor, a descriptor_length field for indicating a message length of the descriptor, and other fields for indicating cell information. More specifically, the cell information includes a cell_id field for indicating a cell ID, a cell_latitude field for indicating a latitude of a cell, a cell_longitude field for indicating a longitude of the cell, a cell_extent_of latitude field for indicating an extent of the latitude of the cell, a cell_extent_of longitude field for indicating an extent of the longitude of the cell, a subcell_info_loop_length field for indicating a length of information on a sub-cell belonging to the cell, a cell_id_extension field for indicating an ID of the sub-cell belonging to the cell, a subcell_latitude field for indicating a latitude of the sub-cell, a subcell_longitude field for indicating a longitude of the sub-cell, a subcell_extent_of_latitude field for indicating an extent of the latitude of the sub-cell, and a subcell_extent_of_longitude field for indicating an extent of the longitude of the sub-cell. The sub-cell is a small cell belonging to each cell, and generally implies a region covered by a low power transmitter such as a repeater or a transposer.

TABLE 2

| Syntax | Number of bits |
|---|---|
| cell_frequency_link_descriptor( ){ | |
| descriptor_tag | 8 |
| descriptor_length | 8 |
| for (i=0; i<N; i++){ | |
| cell_id | 16 |
| frequency | 32 |
| subcell_info_loop_length | 8 |
| for (j=0; j<N; j++){ | |
| cell_id_extension | 8 |
| transposer_frequency | 32 |
| } | |
| } | |
| } | |

As shown in Table 2 above, the cell_frequency_link_descriptor includes a descriptor_tag field for identifying a descriptor, a descriptor_length field for indicating a message length of the descriptor, and other fields for indicating entire cell information. More specifically, the cell information includes a cell_id field for indicating a cell ID, a frequency field for indicating a frequency of a cell, a subcell_info_loop_length field for indicating a length of information on a sub-cell belonging to the cell, a cell_id_extension field for indicating an ID of the sub-cell belonging to the cell, and a transposer_frequency field for indicating a frequency used in the transposer.

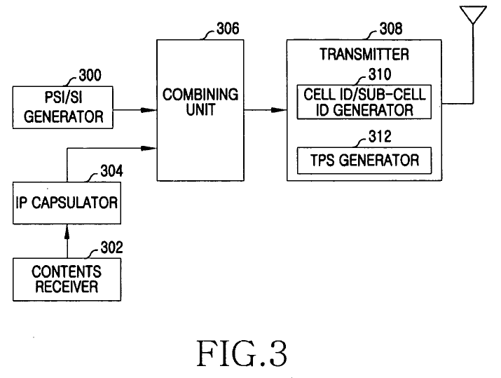

FIG. 3 is a block diagram illustrating a transmitting apparatus of a BS in a DVB-H system according to an exemplary embodiment of the present invention.

Referring to FIG. 3, the BS includes a PSI/SI generator 300, a contents receiver 302, an Internet Protocol (IP) capsulator 304, a combining unit 306, and a transmitter 308. The transmitter 308 includes a cell ID/sub-cell ID generator 310 and a Transmission Parameter Signaling (TPS) generator 312.

The PSI/SI generator 300 generates PSI/SI. Examples of the PSI/SI include a Network Information Table (NIT), a Program Association Table (PAT), a Program Map Table (PMT), an IP/MAC Notification Table (INT), a Session Description Protocol (SDP), etc. Herein, the NIT includes the cell_list_descriptor of Table 1 above and the cell_frequency_link_descriptor of Table 2 above. That is, the PSI/SI generated by the PSI/SI generator 300 includes latitude and longitude information of all cells.

The contents receiver 302 receives digital broadcast contents from a contents provider (not shown).

The IP capsulator 304 performs IP capsulation on data received from the contents receiver 302, that is, the IP capsulator 304 packetizes the received data.

The combining unit 306 combines the PSI/SI received from the PSI/SI generator 300 and the IP-capsulated data received from the IP capsulator 304.

The transmitter 308 transmits the data received from the combining unit 306 and TPS provided from the TPS generator 312 to respective antennas at a corresponding transmission time. Herein, the TPS includes a cell ID of a mobile terminal and, according to an exemplary embodiment of the present invention, also includes a sub-cell ID. The cell ID/sub-cell ID generator 310 generates a cell ID and a sub-cell ID for each mobile terminal, and outputs the generated cell ID and sub-cell ID for each mobile terminal. The TPS generator 312 generates TPS for each mobile terminal by using the cell ID and the sub-cell ID received from the cell ID/sub-cell ID generator 310.

Meanwhile, an Orthogonal Frequency Division Multiplexing (OFDM) frame of the DVB-H system consists of 68 symbols in total. A TPS bit is transmitted at one designated position for each symbol. Thus, there is a transmission rule for 68 TPS bits in total. Four frames are aggregated to constitute one super-frame. A frame has 8 bits used for a cell ID among the 68 TPS bits. Since 16 bits are required to transmit the cell ID, the DVB-H system transmits the cell ID throughout two frames. That is, one cell ID is transmitted in the 1^{st} and 2^{nd} frames, and is again transmitted in the 3^{rd} and 4^{th} frames.

At present, 4 bits are reserved for future use among the 68 TPS bits. In an exemplary implementation of the present invention, the 4 bits may be used to transmit the sub-cell ID. As specified, the cell ID extension field requires 8 bits in total, and thus may be transmitted throughout two frames similarly to the cell ID. Herein, the cell ID extension field may be defined as a sub-cell ID for identifying each sub-cell (i.e., sector).

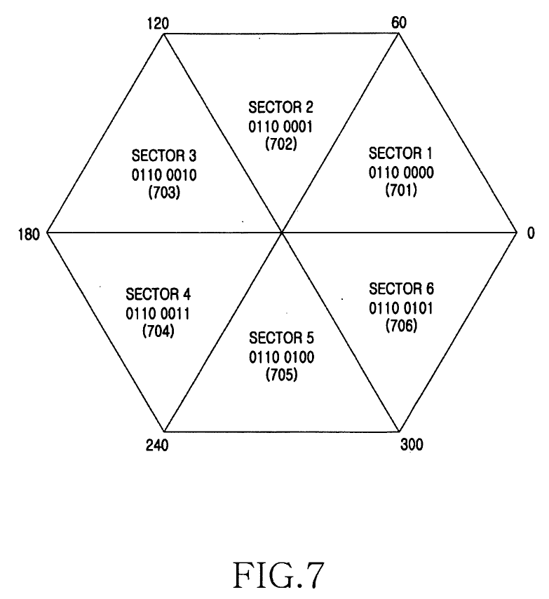

Exemplary embodiments of the present invention propose the cell ID extension for a method of transmitting a sub-cell ID. In this method, 8 bits are used to transmit information on a sector antenna used by a BS so that a mobile terminal may recognize a location of the mobile terminal in a current cell. In an exemplary implementation, the sector antenna is used as an antenna of a BS in each cell, and each sector divided by using its sector antenna is defined as a sub-cell. That is, a sub-cell ID is used by the mobile terminal to identify a sector. Herein, among the 8 bits, the upper 4 bits indicate the number of sectors currently used by the BS, and the remaining 4 bits indicate information on a sector to which the mobile terminal currently belongs. Since the number of bits indicating the number of sectors currently used by the BS is 4, the BS may configure up to 16 sectors. For example, as shown in FIG. 7, if it is assumed that the BS uses 6 sectors 701 to 706, ‘0110’ is assigned to the upper 4 bits among the 8 bits, and the remaining bits are assigned with different values for each sector. Since 6 sectors are assumed, each sector may have a value in the range of 0 to 5, i.e., ‘0000’ to ‘0101’. In case of FIG. 7, ‘0110 0010’ is assigned to 8 bits received by a mobile terminal located in a 3^{rd} sector 703, and ‘0110 0100’ is assigned to 8 bits received by a mobile terminal located in a 5^{th} sector 705. From a perspective of a mobile terminal, in case of 6 sectors, it may be known that each sector covers an angle of 60 degrees, and a range of a sector to which the mobile terminal currently belongs may be predicted by using the lower 4 bits. For example, the 1^{st} sector 701 covers 0 to 60 degrees, and the 4^{th} sector 704 covers 180 to 240 degrees. Herein, the sub-cell ID is used to reduce the number of adjacent cells that are candidates for a handover process.

Similar to the cell ID, the sub-cell ID is transmitted by carrying the upper 4 bits on the 1^{st} and 3^{rd} frames and the lower 4 bits on the 2^{nd} and 4^{th} frames.

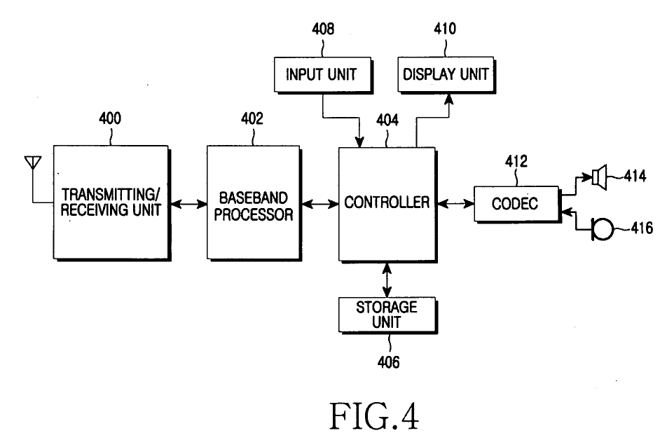

FIG. 4 is a block diagram illustrating a mobile terminal in a DVB-H system according to an exemplary embodiment of the present invention.

Referring to FIG. 4, the mobile terminal includes a transmitting/receiving unit 400, a baseband processor 402, a controller 404, a storage unit 406, an input unit 408, a display unit 410, and a codec 412.

The transmitting/receiving unit 400 down-converts a Radio Frequency (RF) signal received through an antenna and provides the resultant signal to the baseband processor 402. Further, the transmitting/receiving unit 400 transmits a baseband signal received from the baseband processor 402 through the antenna.

The baseband processor 402 processes the baseband signal transmitted/received between the transmitting/receiving unit 400 and the controller 404. For example, in case of transmission, the baseband processor 402 performs a channel coding and spreading function on data to be transmitted, and in case of reception, the baseband processor 402 performs a de-spreading and channel decoding function on a received signal.

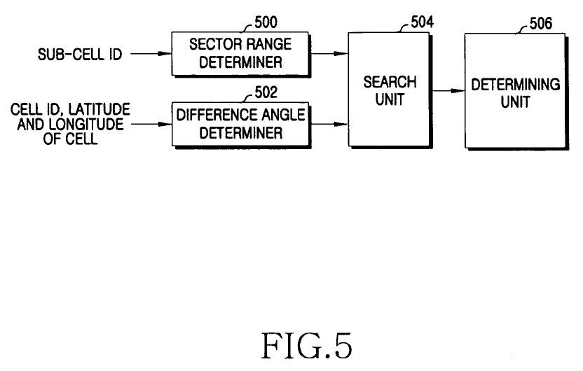

The controller 404 provides overall control to the mobile terminal. For example, a voice call or data communication is processed and controlled by the controller 404. Further, in addition to a general operation, the controller 404 recognizes a location of the mobile terminal by using a sub-cell ID obtained by receiving TPS from the BS in absence of a GPS, and processes a function for performing a faster handover than the conventional method by using the location of the mobile terminal. Details of the controller 404 will be described below in more detail with reference to FIG. 5.

The storage unit 406 stores a microcode of a program, by which the controller 404 is processed and controlled, and a variety of reference data. In particular, the storage unit 406 stores a program for recognizing the location of the mobile terminal by using the sub-cell ID obtained by receiving the TPS from the BS in absence of the GPS and for processing the function for performing the faster handover than the conventional method by using the location of the mobile terminal. Further, the storage unit 406 stores temporary data that is generated while various programs are performed, and also stores a cell ID and sub-cell ID obtained by receiving the TPS from the BS and all cell's latitude and longitude information obtained by receiving PSI/SI from the BS.

The input unit 408 includes a plurality of function keys such as numeral key buttons of ‘0’ to ‘9’, a menu button, a cancel (or delete) button, a confirm button, a talk button, an end button, an Internet access button, a navigation (or direction) key button (i.e., ▴/▾/ [symbol] / [symbol] ), and a character input key. Key input data, which is input when the user presses these keys, is provided to the controller 404.

The display unit 410 displays information such as state information, which is generated while the mobile terminal operates, limited numeral characters, large-sized moving and still pictures, etc. The display unit 410 may be a color Liquid Crystal Display (LCD). If the LCD is provided as a touch screen, the display unit 410 may perform a part or all of the functions of the input unit 408.

The codec 412 converts digital data provided from the controller 404 into an analog voice signal and outputs the analog signal through a speaker 414. Further, the codec 412 converts the voice signal received through a microphone 416 into digital data and provides the digital data to the controller 404.

FIG. 5 is a block diagram illustrating an apparatus for determining a target adjacent cell to which a controller of a mobile terminal without a GPS performs a handover by recognizing a location of the mobile terminal in a DVB-H system according to an exemplary embodiment of the present invention.

Referring to FIG. 5, the controller includes a sector range determiner 500 for determining a sector range, a difference angle determiner 502 for determining a difference angle between adjacent cells, a search unit 504 for finding a candidate adjacent cell, and a determining unit 506 for determining a target adjacent cell.

The sector range determiner 500 determines a range of a sector to which the mobile terminal in a cell belongs by using a mobile terminal's sub-cell ID obtained by receiving TPS from a BS.

The difference angle determiner 502 determines a relative difference angle between a current cell and an adjacent cell by using a mobile terminal's cell ID obtained by receiving the TPS from the BS and the adjacent cell's latitude and longitude information obtained by receiving PSI/SI from the BS.

The search unit 504 determines whether the handover of the mobile terminal is required according to changes in a communication environment, and, if the handover is required, searches for adjacent cells, of which the difference angle from the current cell is included in the sector range, by using the sector range determined by the sector range determiner 500 and the difference angle determined by the difference angle determiner 502.

The determining unit 506 scans the found adjacent cells. According to the scanning result, the determining unit 506 determines the target adjacent cell to which the handover is to be performed.

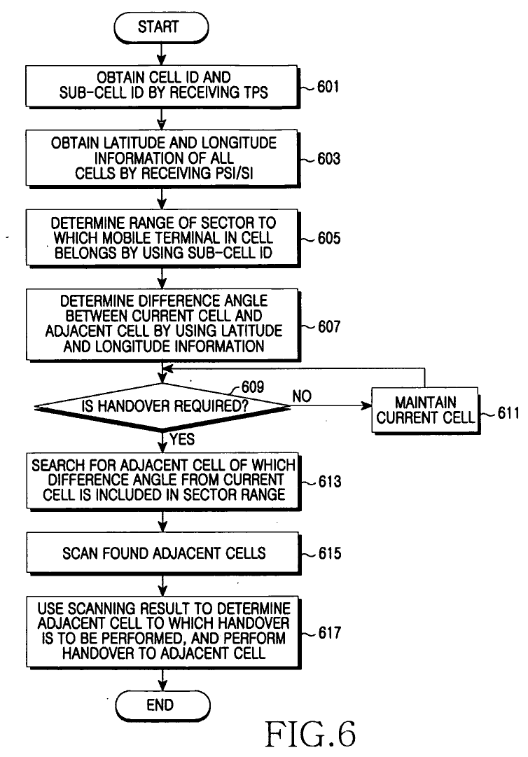

FIG. 6 is a flowchart illustrating a method of determining a target adjacent cell to which a mobile terminal without a GPS performs a handover by recognizing a location of the mobile terminal in a DVB-H system according to an exemplary embodiment of the present invention.

Referring to FIG. 6, in step 601, the mobile terminal obtains its cell ID and sub-cell ID by receiving TPS from a BS.

In step 603, the mobile terminal obtains latitude and longitude information of other cells by receiving PSI/SI from the BS.

In step 605, the mobile terminal determines a range of a sector to which the mobile terminal belongs by using the sub-cell ID of the mobile terminal.

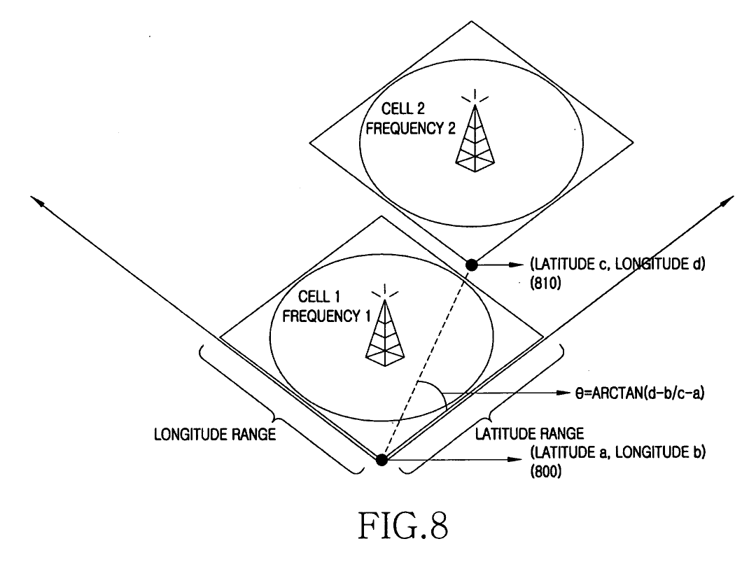

In step 607, the mobile terminal determines a relative difference angle between a current cell and an adjacent cell by using the obtained cell ID of the mobile terminal and the latitude and longitude information of all cells. For example, as shown in FIG. 8, if it is assumed that a cell 1, having a location (a, b) 800, is a center cell in which the mobile terminal is currently present, a relative difference angle of a cell 2, having a location (c, d) 810, viewed from the cell 1, may be simply determined by using Equation (1) below.

difference_angle=arc tan(d−b)/(c−a) (1)

In Equation (1), a denotes a latitude of the cell 1, b denotes a longitude of the cell 1, c denotes a latitude of the cell 2, and d denotes a longitude of the cell 2. As such, the relative difference angle between the current cell and the adjacent cell is determined using the same method used to determine a difference angle of a general coordinate axis. Accordingly, the mobile terminal may determine all relative difference angles between the current cell and other cells. Further, the mobile terminal may compare the determined difference angles with an angle range of a cell to which the mobile terminal currently belongs. That is, the mobile terminal may compare a sector range, and then may use the comparison result in a handover process.

In step 609, the mobile terminal determines whether handover of the mobile terminal is required according to changes in a communication environment. For example, the mobile terminal may examine whether a parameter (e.g., RSSI, SNR, etc.) decreases below a reference value. If the handover is not required, the mobile terminal maintains a current cell in step 611. Then, returning to step 609, subsequent steps are repeated.

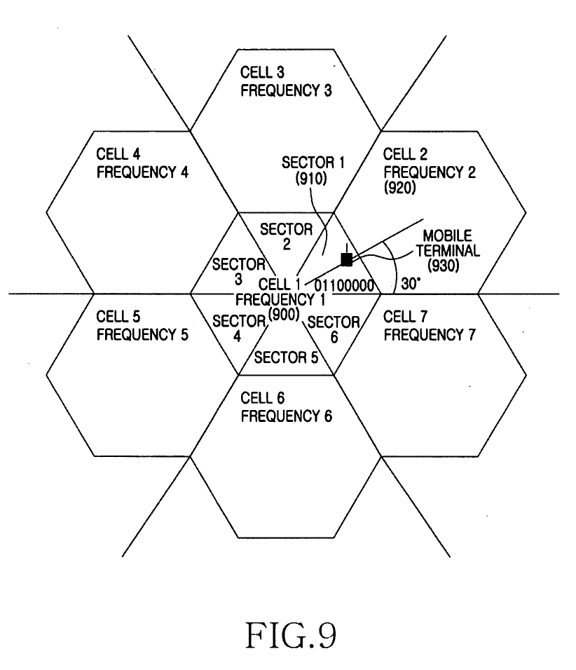

On the other hand, if the handover is required, in step 613, the mobile terminal searches for adjacent cells, of which the difference angle from the current cell is included in the sector range, by using the determined sector range and the determined difference angle. For example, as shown in FIG. 9, it is assumed that only 7 adjacent cells are considered and a 1^{st} cell 900 is a center cell in which the mobile terminal 930 is currently located. The mobile terminal 930 is located in a 1^{st} sector 910 of the first cell 900 and thus has a sector range of 0 to 60 degrees. In addition, a difference angle between adjacent cells is included in the sector range and is 30 degrees with respect to a 2^{nd} cell 920. Although a difference angle between cell centers is determined herein for convenience, an actually determined difference angle may be a difference angle between cell edges as shown in FIG. 8. Accordingly, an adjacent cell to which the handover is possible is limited to the 2^{nd} cell 920. That is, if the adjacent cells need to be scanned, scanning is performed only on the 2^{nd} cell and not on all adjacent cells. Although only 6 sectors are considered in FIG. 9, this is for exemplary purposes only, and thus more adjacent cells may be distributed in practice.

In step 615, the mobile terminal scans the found adjacent cells. In step 617, by using the scanning result, the mobile terminal determines the target adjacent cell to which the handover is to be performed, and then performs the handover to the adjacent cell.

Thereafter, the procedure of FIG. 6 ends.

In the illustrated example, sectors existing in each cell are divided using sector antennas. However, since the same frequency is used in practice, movement between sectors is not different from movement in a cell covered by an omni-directional antenna.

As described above, according to an exemplary method proposed in the present invention, a BS transmits a sub-cell ID to a mobile terminal using TPS in a DVB-H system. Also, the mobile terminal recognizes a location of the mobile terminal by using the sub-cell ID and reduces a candidate group of adjacent cells to which a handover is possible. Therefore, there is an advantage in that the mobile terminal may perform the handover within a short period of time, and a seamless service may be provided by avoiding a possibility that a service currently being provided in a cell to which the mobile terminal currently belongs is stopped due to a delay occurring when all adjacent cells are scanned. Further, in comparison with the conventional handover, power consumption may be reduced by decreasing a frequency search time of an adjacent cell during an off time, which is advantageous and significantly similar to a mobile terminal with a GPS. Furthermore, since an additional GPS is not required, cost and complexity of the mobile terminal are not increased, and the above effects are maximized when each cell is segmented into up to 16 sectors.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the description of the invention but by the appended claims and their equivalents, and all differences within the scope will be construed as being included in the present invention.

What is claimed is:

1. A method of supporting a handover of a mobile communication terminal, the method comprising:
receiving a sub-cell IDentifier (ID) from a Base Station (BS) using Transmission Parameter Signaling (TPS);
recognizing a location of the mobile terminal using the received sub-cell ID; and
determining a candidate group of adjacent cells, to which handover is possible, using the recognized location information of the mobile terminal.

2. The method of claim 1, wherein the sub-cell ID comprises at least one of a number of sectors used by the BS and information on a sector in which the mobile terminal is currently located.

3. The method of claim 2, wherein the sub-cell ID is received among reserved bits of TPS bits.

4. The method of claim 3, wherein the sub-cell ID is received throughout two frames, the sub-cell ID transmitted using the reserved bits during one frame indicates the number of sectors currently used by the BS, and the sub-cell ID transmitted using the reserved bits during the remaining frames indicates the sector in which the mobile terminal is currently located.

5. The method of claim 2, wherein the recognizing of the location of the mobile terminal comprises determining a range of a sector to which the mobile terminal in the cell belongs using the received sub-cell ID.

6. The method of claim 5, further comprising:
receiving a cell ID using the TPS;
receiving each cell's latitude and longitude information from the BS using Program Specific Information (PSI)/Service Information (SI); and
determining a difference angle between a current cell and an adjacent cell using the cell ID and each cell's latitude and longitude information.

7. The method of claim 6, wherein the difference angle is determined using the equation:
difference_angle=arc tan(d−b)/(c−a),
where a denotes a latitude of the current cell, b denotes a longitude of the current cell, c denotes a latitude of the adjacent cell, and d denotes a longitude of the adjacent cell.

8. The method of claim 6, wherein the determining of the candidate group of the adjacent cells comprises searching for adjacent cells of which the difference angle from the current cell is included in the sector range.

9. An apparatus for supporting a handover of a mobile communication terminal, the apparatus comprising:
a receiver for receiving a sub-cell IDentifier (ID) from a Base Station (BS) using Transmission Parameter Signaling (TPS); and
a controller for recognizing a location of the mobile terminal using the received sub-cell ID, and for determining a candidate group of adjacent cells, to which the handover is possible, using the recognized location information of the mobile terminal.

10. The apparatus of claim 9, wherein the sub-cell ID comprises at least one of a number of sectors used by the BS and information on a sector in which the mobile terminal is currently located.

11. The apparatus of claim 10, wherein the sub-cell ID is received among reserved bits of TPS bits.

12. The apparatus of claim 11, wherein the sub-cell ID is received throughout two frames, the sub-cell ID transmitted using the reserved bits during one frame indicates the number of sectors currently used by the BS, and the sub-cell ID transmitted using the reserved bits during the remaining frames indicates the sector in which the mobile terminal is currently located.

13. The apparatus of claim 10, wherein the controller recognizes the location of the mobile terminal by determining a range of a sector, to which the mobile terminal in the cell belongs, using the received sub-cell ID.

14. The apparatus of claim 13,
wherein the receiver receives each cell's latitude and longitude information from the BS using Program Specific Information (PSI)/Service Information (SI), and
wherein the controller determines a difference angle between a current cell and an adjacent cell using the cell ID and the each cell's latitude and longitude information.

15. The apparatus of claim 14, wherein the difference angle is determined using the equation:
difference_angle=arc tan(d−b)/(c−a),
where a denotes a latitude of the current cell, b denotes a longitude of the current cell, c denotes a latitude of the adjacent cell, and d denotes a longitude of the adjacent cell.

16. An apparatus of a Base Station (BS) for supporting a handover of a mobile communication terminal, the apparatus comprising:
a cell IDentifier/sub-cell IDentifier (cell ID/sub-cell ID) generator for generating a cell ID and a sub-cell ID;
a Transmission Parameter Signaling (TPS) generator for generating TPS including the cell ID and sub-cell ID; and
a transmitter for transmitting the TPS.

17. The apparatus of claim 16, wherein the cell ID/sub-cell ID generator generates a sub-cell ID for each mobile terminal served by the BS.

18. The apparatus of claim 16, wherein the sub-cell is generated by including at least one of a number of sectors used by the BS and information on a sector in which a mobile terminal is currently located.

19. The apparatus of claim 18, wherein the sub-cell ID is transmitted using reserved bits among TPS bits.

20. The apparatus of claim 19, wherein the sub-cell ID is transmitted throughout two frames, the sub-cell ID transmitted using the reserved bits during one frame indicates the number of sectors currently used by the BS, and the sub-cell ID transmitted using the reserved bits during the remaining frames indicates the sector in which the mobile terminal is currently located.
